(19) United States
(12) Patent Application Publication
(10) Pub. No.: US 2026/0029936 A1
(43) Pub. Date: Jan. 29, 2026

(54) READ BOOSTER FOR OPERATIONAL DATA OF A MEMORY SYSTEM

(71) Applicant: Micron Technology, Inc., Boise, ID (US)

(72) Inventors: Chaohui Liu, Shanghai (CN); Ming Ma, Shanghai (CN); Liang Ge, Shanghai (CN)

(21) Appl. No.: 19/267,296

(22) Filed: Jul. 11, 2025

Related U.S. Application Data
(60) Provisional application No. 63/674,915, filed on Jul. 24, 2024.

(51) Int. Cl. G06F 3/06

(52) U.S. Cl. CPC G06F 3/0625; G06F 3/0659; G06F 3/0673

(57) ABSTRACT

Methods, systems, and devices for read booster for operational data of a memory system are described. A memory system may access system-related data in a partition via a mapping table stored in volatile memory as opposed to loading multi-level logical-to-physical tables from non-volatile memory. For example, a host system may provide a logical block address (LBA) range of system-related data to be written to the partition using a first command. The memory system may contiguously store physical block addresses (PBAs) corresponding to the LBA range into one or more segments of the partition. To access a given PBA in a segment, the memory system may access one or more parameters stored in the mapping table, such as a starting PBA and size (e.g., in PBAs) for each respective segment.

### CROSS REFERENCE

The present Application for Patent claims priority to U.S. Patent Application No. 63/674,915 by Liu et al., entitled “READ BOOSTER FOR OPERATIONAL DATA OF A MEMORY SYSTEM,” filed Jul. 24, 2024, which is assigned to the assignee hereof, and which is expressly incorporated by reference in its entirety herein.

### TECHNICAL FIELD

The following relates to one or more systems for memory, including read booster for operational data of a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports a read booster for operational data of a memory system in accordance with examples as disclosed herein.

FIG. 2 shows an example of a block diagram that supports a read booster for operational data of a memory system in accordance with examples as disclosed herein.

FIG. 3 shows an example of a process that supports a read booster for operational data of a memory system in accordance with examples as disclosed herein.

FIG. 4 shows a block diagram of a memory system that supports a read booster for operational data of a memory system in accordance with examples as disclosed herein.

FIG. 5 shows a flowchart illustrating a method or methods that supports a read booster for operational data of a memory system in accordance with examples as disclosed herein.

### DETAILED DESCRIPTION

Some memory systems may include a partition (e.g., a super partition, a range of logical block addresses (LBAs)) for storing system-related data. For example, system-related data may include system files, configuration settings, installed applications, or other data that an operating system of the memory system may use to perform its tasks. In some examples, a memory system may implement multiple levels of logical-to-physical (L2P) tables that map LBAs to a physical block addresses (PBAs). For example, entries of a first-level L2P table may store pointers to one or more second-level L2P tables, and entries in the second-level L2P tables may store pointers to one or more terminal tables (e.g., third-level L2P tables) that translate respective LBAs to PBAs. In some examples, the memory system may store the first-level L2P table in volatile memory for relatively faster access, while subsequent-level tables (e.g., second or third-level L2P tables) may be stored in non-volatile memory (e.g., which may be loaded to the volatile memory in response to being indicated by the first-level L2P table). Dynamically loading subsequent-level L2P tables from non-volatile memory to volatile memory may increase latency in performing an access operation. However, the memory system may not have sufficient resources (e.g., storage space in an SRAM or other cache) to store the subsequent-level L2P tables in the volatile memory. Thus, it may be beneficial to compress subsequent-level L2P tables such that the memory system may access the system-related data relatively quickly without occupying a relatively large quantity of volatile memory resources.

The techniques described herein may enable a memory system to access system-related data stored to a super partition via a mapping table stored in volatile memory (e.g., as opposed to loading multi-level L2P tables from non-volatile memory). For example, a host system may provide an LBA range of system-related data to be written to the memory system using a Vendor Unique (VU) command (e.g., sometimes referred to as a vendor specific command as well). The memory system may contiguously store PBAs corresponding to the LBA range into one or more segments in the partition. To access a given PBA in a segment, the memory system may access the mapping table stored in the volatile memory. The mapping table may include one or more parameters, such as a starting PBA and size (e.g., in PBAs) for each respective segment. For example, the memory system may determine that an LBA indicated in an access command is within the LBA range and corresponds to a first segment of the partition. In accordance with the starting PBA and size of the first segment, the memory system may determine the corresponding PBA. Storing the PBAs contiguously and accessing the one or more parameters in the mapping table may enable the memory system to determine a PBA, using an LBA, without loading second-level and third-level L2P tables from the non-volatile memory, which may enhance read performance (e.g., reduce read latency, thereby providing a read “boost”) while occupying less volatile memory.

In addition to applicability in memory systems as described herein, techniques for a read booster for operational data of a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by accessing data in a partition via a table stored in volatile memory rather than accessing multi-level L2P tables stored in non-volatile memory prior to accessing the data, which may reduce latency associated with basic system processes and applications (e.g., that may use data from the partition), among other benefits.

Features of the disclosure are illustrated and described in the context of systems, devices, and circuits. Features of the disclosure are further illustrated and described in the context of block diagrams, process flows, and flowcharts.

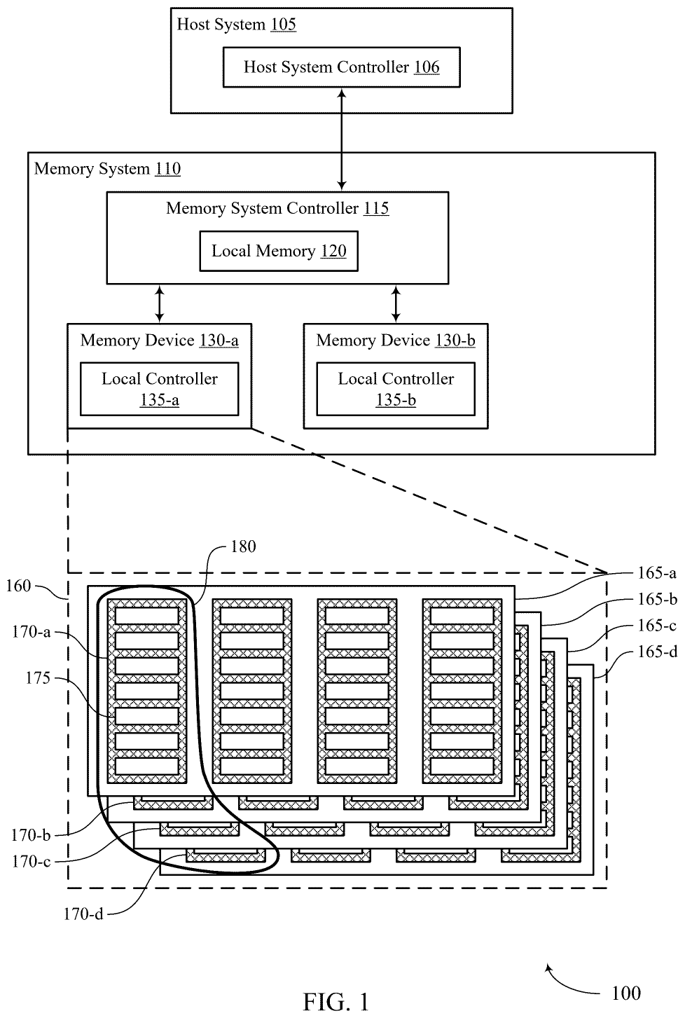

FIG. 1 shows an example of a system 100 that supports a read booster for operational data of a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include random access memory (RAM), static RAM (SRAM), or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

Some memory systems 110 may include a partition (e.g., a super partition, a range of LBAs) for storing system-related data. For example, system-related data may include system files, configuration settings, installed applications, or other data that an operating system of the memory system 110 may use to perform its tasks. The partition may be accessed to launch one or more applications. For example, the system-related data may be formatted according to an Application Package Kit (APK). In some examples, the partition may be stored in a respective memory device 130, or across multiple memory devices 130. For example, memory device 130-a may include one or more portions of the partition and the memory device 130-b may include one or more other portions of the partition (e.g., the memory device 130-a may store a first part of the system-related data and the memory device 130-b may store a second part of the system-related data).

In some examples, a memory system 110 may implement multiple levels of L2P tables that map LBAs to PBAs. For example, entries of a first-level L2P table may store pointers to one or more second-level L2P tables, and entries in the second-level L2P tables may store pointers to one or more terminal tables (e.g., third-level L2P tables) that translate respective LBAs to PBAs. In some examples, the memory system 110 may store the first-level L2P table in volatile memory for faster access, while subsequent-level tables (e.g., second or third-level L2P tables) may be stored in non-volatile memory (e.g., which may be loaded to the volatile memory in response to being indicated by the first-level L2P table). For example, the memory system 110 may store a first-level L2P table in the local memory 120, while storing subsequent-level L2P tables in one or more memory devices 130. Dynamically loading subsequent-level L2P tables from non-volatile memory (e.g., such as in a memory device 130-a) to the local memory 120 may increase latency in performing an access operation. However, the memory system 110 may not have sufficient resources (e.g., storage space) if the subsequent-level L2P tables were stored in the local memory 120. Thus, it may be beneficial to compress subsequent-level L2P tables such that the memory system 110 may access the system-related data relatively quickly while using fewer volatile memory resources.

The techniques described herein may enable a memory system 110 to access the system-related data stored to a super partition via a mapping table stored in the local memory 120 (e.g., as opposed to loading multi-level L2P tables from non-volatile memory). For example, a host system 105 may provide an LBA range of system-related data to be written to the memory system 110 using a VU command. The memory system 110 may contiguously store PBAs corresponding to the LBA range into one or more segments in the partition. To access a given PBA in a segment, the memory system 110 may access the mapping table stored in the local memory 120. The mapping table may include one or more parameters, such as a starting PBA and size (e.g., in PBAs) for each respective segment. For example, the memory system 110 may determine that an LBA indicated in an access command is within the LBA range and corresponds to a first segment of the partition. In accordance with the starting PBA and size of the first segment, the memory system 110 may determine the corresponding PBA. Storing the PBAs contiguously and the one or more parameters in the mapping table may enable the memory system 110 to determine a PBA, using an LBA, without loading second-level and third-level L2P tables from the one or more memory devices 130, which may enhance read performance (e.g., reduce read latency, thereby providing a read “boost”) while occupying less local memory 120.

The system 100 may include any quantity of non-transitory computer readable media that support a read booster for operational data of a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

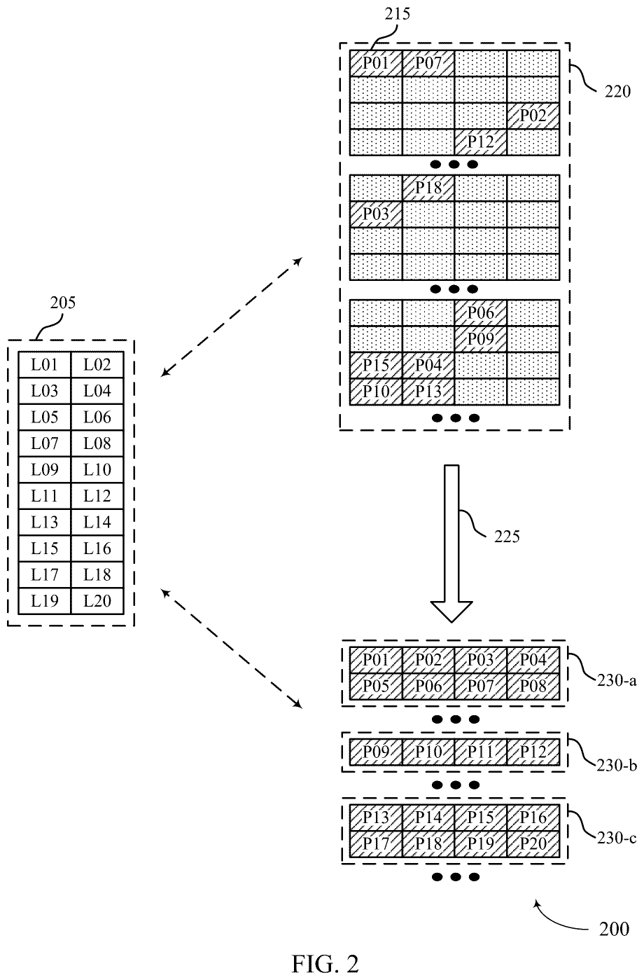

FIG. 2 shows an example of a block diagram 200 that supports a read booster for operational data of a memory system in accordance with examples as disclosed herein. The block diagram may include an LBA range 205, an unorganized segment 220, and one or more organized segments 230. In some examples, the block diagram 200 may represent a quantity of blocks in a partition located in one or more memory devices (e.g., a memory device 130). The memory system (e.g., the memory system 110) may read data from or write data to one or more physical blocks depicted by the block diagram 200 in response to receiving one or more access commands from a host system (e.g., the host system 105).

Some memory systems may implement multi-level L2P tables to map LBAs to PBAs. That is, a memory system may receive an access command indicating an LBA, and the memory system may translate the LBA to a corresponding PBA by traversing through the multi-level L2P tables. For example, the memory system may start with a first-level L2P table, where each entry may include a pointer to a second-level L2P table. The memory system may continue until a terminal-level L2P table points to the corresponding PBA (e.g., each entry in a second-level L2P table may include a pointer to a terminal third-level L2P that points to a corresponding PBA). In some examples, the first-level L2P table may be stored in volatile memory while subsequent-level L2P tables (e.g., the second-level and the third-level L2P tables) may be stored in non-volatile memory. Volatile memory may allow for relatively faster access compared to non-volatile memory, but volatile memory may have more limited storage space. In some examples, loading subsequent-level L2P tables may increase access latency in response to reading a respective L2P table from the non-volatile memory to the volatile memory. The access latency may be reduced if the subsequent-level tables were stored in the volatile memory, but the memory system may not include sufficient volatile memory resources. For example, the volatile memory may be unable to store all of the subsequent-level L2P tables.

In some examples, a memory system may include a partition for storing system-related data. In some cases, the partition may be referred to as a “super partition” and may correspond to a range of LBAs (e.g., a range of contiguous LBAs). System-related data (e.g., or operational data) may include data or information related to the operation of an operating system. For example, system-related data may include system files, configuration settings, installed applications, or other data the operating system may use to perform its tasks. The partition may be read-only in some examples, meaning that data may be read from the partition after it is established and/or updated. For example, in response to a user starting an application, the memory system may initiate an APK runtime that reads data stored in the partition (e.g., in one or more libraries) as well as data stored in one or more user partitions (e.g., partitions that may store user data). In some examples, data stored in the partition may become non-contiguous (e.g., or be stored as non-contiguous). For example, updating or modifying system-related data in the partition (e.g., via a system update) may cause one or more PBAs corresponding to the data to become non-contiguous and, in some examples, distributed across the PBAs of the partition.

In some applications, a quantity of read commands to the partition may be relatively high. For example, in some applications, read commands to the partition may constitute a majority of the total read commands during the runtime of those applications. The remaining read commands (e.g., a minority of all read commands) may occur in partitions storing user-related data, meta data, or some other data (e.g., application information data). Thus, it may be beneficial to decrease latency associated with reading from multiple-level L2P tables to access data stored in the partition.

The techniques described herein enable a memory system to access data stored in the partition via a mapping table without reading from multi-level L2P tables stored in non-volatile memory. For example, the memory system may receive, from a host system, a VU command indicating an LBA range 205. In some cases, the LBA range 205 may be set after an image is downloaded (e.g., the LBA range 205 may be static after data is stored to the partition). In response to receiving the VU command, the memory system may store data to one or more contiguous PBA segments corresponding to the LBA range 205. Storing data to contiguous PBAs may enable the memory system to maintain the mapping table in the volatile memory, and the mapping table may include a starting PBA and size for each segment. In effect, the memory system may “sequentialize” the data so that a sequential quantity of LBAs map to a sequential quantity of PBAs. Thus simplifying the L2P mapping for that data and allowing the L2P mapping to be compressed. In some examples, the mapping table may enable the memory system to determine a PBA, using the LBA, without loading an L2P table from the non-volatile memory in response to receiving a read command for a LBA included in the LBA range 205.

For example, the memory system may map the LBA range 205 to PBAs 215 in one or more unorganized segments 220 of the partition. An unorganized segment 220 may refer to a portion of the partition that includes data corresponding to the LBA range 205 that is stored in non-contiguous PBAs 215. For example, as shown in FIG. 2, the one or more unorganized segments 220 include data stored to non-contiguous PBAs 215 that correspond to the LBA range 205 (e.g., P01, P07, or P02). In some examples, the memory system may initially store data to contiguous PBAs 215, but after subsequent accesses, or updates, to the data, the data may be stored to non-contiguous PBAs 215 throughout the partition.

In response to receiving the VU command indicating the LBA range 205, the memory device may re-organize data stored to the PBAs 215 via a maintenance operation 225. The maintenance operation 225 may re-organize, re-layout, re-arrange, or perform other such similar operations such that the data stored to the PBAs 215 are stored contiguously into one or more organized segments 230. In some other examples, the memory device may contiguously store data to the one or more organized segments 230 without performing a maintenance operation 225. For example, there may be no prior unorganized segments 220. In some examples, the memory system may perform the maintenance operation 225 as part of a background operation (e.g., as part of one or more memory management operations). For example, the memory system may perform the maintenance operation 225 between access operations or during an idle mode of the memory system. Additionally, or alternatively, the memory system may perform the maintenance operation 225 in response to a timer expiration (e.g., every X seconds), in response to an access operation counter threshold (e.g., every X access commands), or both.

The mapping table may store a starting PBA and length (e.g., size), or quantity, of PBAs in each of the organized segments 230. As described herein, an organized segment 230 may refer to a grouping, portion, or range of contiguous PBAs within the partition that correspond to the LBA range 205. For example, the LBA range 205 may include L01, L02, . . . Ln and the PBAs 215 may include P01, P02, . . . Pn. In the example of FIG. 2, the memory system may allocate three organized segments 230 of contiguous PBAs 215 for the LBA range 205 received from the host system. Allocating the segments may refer to assigning a specific portion, set, or range of PBAs for storing data associated with the LBA range 205.

In some examples, the organized segments 230 may be stored consecutively in the partition. For example, a first organized segment 230-a, a second organized segment 230-b, and a third organized segment 230-c may occur consecutively (e.g., contiguously) in the partition (e.g., without any PBAs 215 that may not correspond to the LBA range 205 between each of the organized segments 230). In some other examples, the organized segments 230 may be stored in different portions of the partition. For example, the first organized segment 230-a may be stored in a first portion of the partition and the second organized segment 230-b may be stored in a second portion of the partition (e.g., such that there may be one or more PBAs not associated with the LBA range 205 between the first organized segment 230-a and the second organized segment 230-b).

The starting PBAs of the contiguous PBA segments (e.g., P01, P09, and P13) and the quantities (e.g., quantity of contiguous PBAs in a respective organized segment 230) may be stored in the mapping table in volatile memory. For example, the mapping table may store P01 with a quantity of eight PBAs 215, P09 with a quantity of four PBAs 215, and P13 with a quantity of eight PBAs 215 for a first organized segment 230-a, a second organized segment 230-b, and a third organized segment 230-c, respectively.

Storing such parameters for each respective organized segment 230 may enable the memory system to translate a given LBA to its corresponding PBA 215 without loading an L2P table from non-volatile memory. For example, the memory system may receive an access command indicating a first LBA within a first range [L01, L01+size1) corresponding to the first organized segment 230-a, where size1 may be the quantity of PBAs 215 in the first organized segment 230-a. The memory system may obtain the corresponding PBA 215 by adding an offset quantity of PBAs (LBA-L01) to the starting PBA of the first organized segment 230-a (e.g., P01). For example, to obtain a PBA corresponding to L04, the memory system may add an offset quantity of 3 to P01 (e.g., L04−L01=3).

The memory system may obtain a corresponding PBA for any LBA in the LBA range 205 using a same or a similar process. For example, the memory system may receive an access command indicating a second LBA within a second range [L01+size1, L01+size1+size2) corresponding to the second organized segment 230-b, where size2 may be the quantity of PBAs 215 in the second organized segment 230-b. The memory system may obtain the corresponding second PBA 215 by adding an offset quantity (LBA−L01−size1) to the starting PBA of the second organized segment 230-b (e.g., P09). For example, to obtain a PBA corresponding to L10, the memory system may add an offset quantity of 1 to P09 (e.g., L10−L01−8=1).

As a third example, the memory system may receive an access command indicating a third LBA within a third range [L01+size1+size2, L1+size1+size2+size3) corresponding to the third organized segment 230-c, where size3 may be the quantity of PBAs 215 in the third organized segment 230-c. The memory system may obtain the corresponding third PBA 215 by adding an offset quantity (LBA−L01−size1−size2) to the starting PBA of the third organized segment 230-c (e.g., P13). For example, to obtain a PBA corresponding to L18, the memory system may add an offset quantity of 5 to P13 (e.g., L18−L01−8−4=5). Although FIG. 2 illustrates three organized segments 230, it may be understood that the techniques described herein may be applied to any quantity of LBA ranges and any quantity of corresponding organized segments 230 for a respective LBA range 205. For example, a partition may include multiple sets of organized segments 230 corresponding to multiple LBA ranges 205.

Using the mapping table stored in volatile memory and the one more organized segments 230 to obtain a location of a PBA corresponding to an LBA from the LBA range 205 may enhance read performance by avoiding loading of one or more L2P tables from non-volatile memory to obtain the location of the PBA (e.g., thereby providing a read “boost”). In some examples, obtaining the location of the PBA via the mapping table stored in volatile memory may result in relatively consistent performance and less performance variation compared to retrieving one or more L2P tables from non-volatile memory to obtain the PBA location. Also, by identifying the partition, the memory system may prioritize read operations in response to a host reading the partition, which may enhance the read performance from the partition.

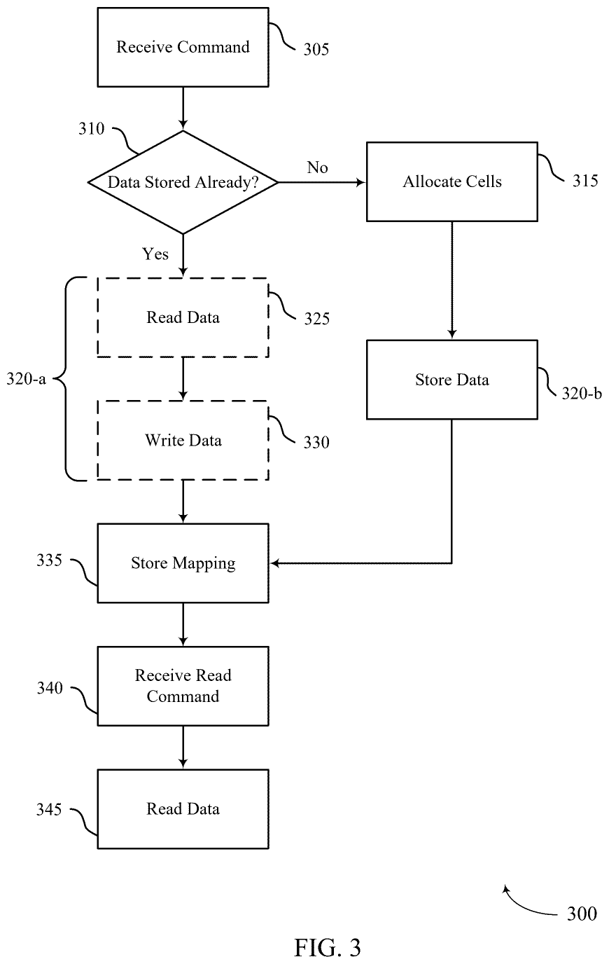

FIG. 3 shows an example of a process 300 that supports a read booster for operational data of a memory system in accordance with examples as disclosed herein. The process 300 may be implemented by the aspects of the system 100 as described with reference to FIG. 1. Aspects of the process 300 may be implemented by one or more controllers, among other components. Additionally, or alternatively, aspects of the process 300 may be implemented as instructions stored in one or more memories (e.g., firmware stored in one or more memories coupled with the memory system). For example, the instructions, when executed by one or more controllers (e.g., the memory system controller 115), may cause the one or more controllers (or a device or a system) to perform the operations of the process 300.

At 305, a first command is received. In some instances, the first access command may indicate a range of LBAs associated with storing information for an operating system. For example, the memory system (e.g., memory system 110) may receive the first command from a host system (e.g., host system 105). The first command may be received by the controller (e.g., the memory system controller 115) of the memory system. The range of LBAs may include a starting LBA and a quantity of LBAs in the range of LBAs. In some cases, the range of LBAs may include of a range of contiguous LBAs. In some examples, the first command may be a VU command.

At 310, it may be determined whether data has been previously stored to a partition. For example, the memory system controller may determine whether the data has been previously stored to the partition. If the memory system controller determines that data has been previously stored to the partition, the memory system may store the data at 320-a. For example, the memory system controller may store the data to contiguous PBAs in the memory system in accordance with receiving the first command. In some cases, the contiguous PBAs may be associated with the range of LBAs.

Storing the data to the contiguous PBAs may include reading, at 325, the data from one or more non-contiguous PBAs and writing, at 330, the data to the contiguous PBAs as part of a maintenance operation. In some examples, the memory system controller may perform the maintenance operation as part of one or more background operations while the memory system is idle. If the memory system controller determines that data has not been previously stored to the partition, the memory system may continue to 315 to allocate one or more contiguous PBAs in response to receiving the first command. At 320-b, data may be stored in response to the memory system allocating the contiguous PBAs.

At 335, a mapping between the range of LBAs and the contiguous PBAs may be stored to a volatile memory of the memory system. For example, the memory system controller may store the mapping (e.g., a mapping table) to the volatile memory (e.g., the local memory 120). The mapping may include the range of LBAs, a starting PBA, and a first quantity of addresses of the contiguous PBAs.

At 340, a first read command for the data may be received after storing the data to the contiguous PBAs. For example, the memory system controller may receive the first read command. The first read command may include at least one LBA of the range of LBAs.

At 345, data from the contiguous PBAs may be read in accordance with the stored data, the starting PBA, the first quantity of addresses of the contiguous PBAs, and the LBA of the range of LBAs. For example, the memory system controller may read the data from the contiguous PBAs in accordance with the first read command and the mapping stored in the volatile memory.

In some examples, the contiguous PBAs may include at least a first portion of contiguous PBAs, a second portion of contiguous PBAs, and a third portion of contiguous PBAs. Each portion may be associated with a respective starting LBA and a respective quantity of PBAs. For example, the memory system may receive a second read command that includes a first LBA of the range of LBAs. The memory system controller may determine whether the first portion of contiguous PBAs is associated with the first LBA of the range of LBAs. If it is, the memory system controller may read data stored to non-volatile memory cells of the first portion of contiguous PBAs. If the first portion of contiguous PBAs is not associated with the first LBA, the memory system may determine whether other portions (e.g., a second or third portion) of contiguous PBAs are associated with the first LBA. In some examples, the starting PBA of the first portion may correspond to the first LBA of the range of LBAs.

In another example, the memory system may receive a third read command that includes a second LBA of the range of LBAs. The memory system controller may determine whether the second portion of contiguous PBAs is associated with the second LBA of the range of LBAs. If it is, the memory system controller may read data stored to non-volatile memory cells of the second portion of contiguous PBAs. If the first portion of contiguous PBAs is not associated with the second LBA, the memory system controller may determine whether other portions (e.g., the first or third) of contiguous PBAs are associated with the second LBA. In some examples, the starting PBA of the second portion may correspond to the second LBA and may be consecutive to an ending PBA of the first portion. Thus, a memory system may enhance read performance (e.g., implement a “read booster)” by receiving a VU command indicating an LBA range, storing or allocating data to contiguous PBAs, storing a mapping indicating a starting PBA and contiguous PBA sizes, and reading data using the mapping stored in volatile memory (e.g., RAM).

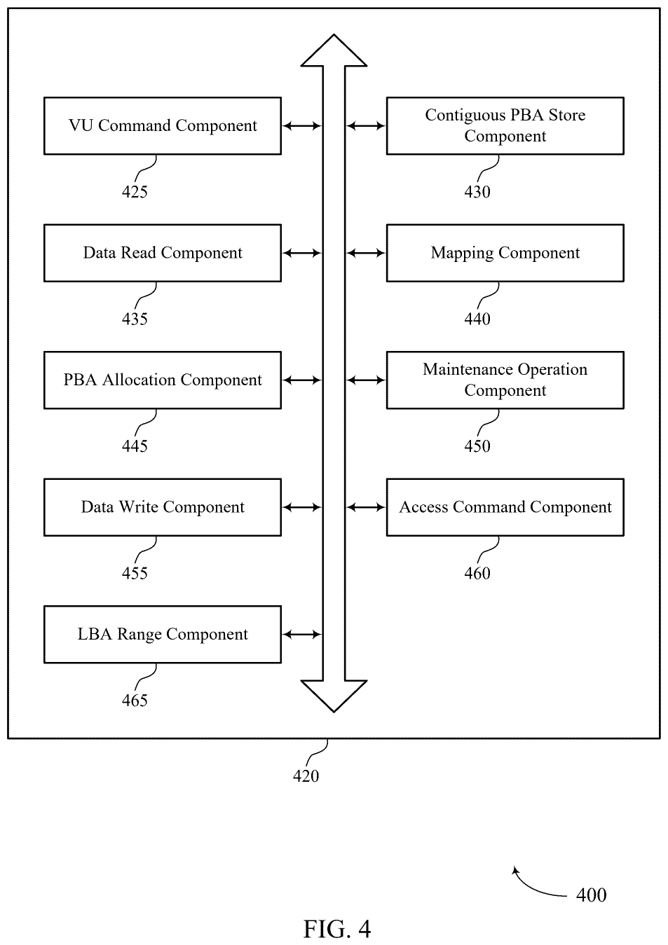

FIG. 4 shows a block diagram 400 of a memory system 420 that supports a read booster for operational data of a memory system in accordance with examples as disclosed herein. The memory system 420 may be an example of aspects of a memory system as described with reference to FIGS. 1 through 3. The memory system 420, or various components thereof, may be an example of means for performing various aspects of read booster for operational data of a memory system as described herein. For example, the memory system 420 may include a VU command component 425, a contiguous PBA store component 430, a data read component 435, a mapping component 440, a PBA allocation component 445, a maintenance operation component 450, a data write component 455, an access command component 460, an LBA range component 465, or any combination thereof. Each of these components, or components of subcomponents thereof (e.g., one or more processors, one or more memories), may communicate, directly or indirectly, with one another (e.g., via one or more buses).

The VU command component 425 may be configured as or otherwise support a means for receiving a first command that indicates a range of logical block addresses associated with storing information for an operating system, the range of logical block addresses having a starting logical block address and a quantity of logical block addresses in the range of logical block addresses. The contiguous PBA store component 430 may be configured as or otherwise support a means for storing data to contiguous physical block addresses in the memory system in accordance with receiving the first command, where the contiguous physical block addresses are associated with the range of logical block addresses. The data read component 435 may be configured as or otherwise support a means for reading the data from the contiguous physical block addresses in accordance with storing the data and with a starting physical block address, a first quantity of addresses of the contiguous physical block addresses, and a logical block address of the range of logical block addresses.

In some examples, the mapping component 440 may be configured as or otherwise support a means for storing, to a volatile memory of the memory system, a mapping between the range of logical block addresses and the contiguous physical block addresses, where the mapping includes the range of logical block addresses, the starting physical block address, and the first quantity of addresses of the contiguous physical block addresses.

In some examples, to support reading the data, the access command component 460 may be configured as or otherwise support a means for receiving a first read command for the data after storing the data to the contiguous physical block addresses, where the first read command includes at least one logical block address of the range of logical block addresses, where the data is read from the contiguous physical block addresses in accordance with receiving the first read command and the mapping stored to the volatile memory.

In some examples, the PBA allocation component 445 may be configured as or otherwise support a means for allocating the contiguous physical block addresses in response to receiving the first command, where storing the data is in response to allocating the contiguous physical block addresses.

In some examples, to support storing the data to the contiguous physical block addresses, the maintenance operation component 450 may be configured as or otherwise support a means for reading, as part of a maintenance operation, the data from one or more non-contiguous physical block addresses. In some examples, to support storing the data to the contiguous physical block addresses, the data write component 455 may be configured as or otherwise support a means for writing the data to the contiguous physical block addresses.

In some examples, the maintenance operation is performed as part of one or more background operations. In some examples, the data is stored to the contiguous physical block addresses during a duration that the memory system is idle.

In some examples, the contiguous physical block addresses includes at least a first portion of contiguous physical block addresses, a second portion of contiguous physical block addresses, and a third portion of contiguous physical block addresses. In some examples, each portion is associated with a respective starting logical block address and a respective quantity of physical block addresses.

In some examples, the access command component 460 may be configured as or otherwise support a means for receiving a second read command that includes a first logical block address of the range of logical block addresses. In some examples, the LBA range component 465 may be configured as or otherwise support a means for determining whether the first portion of contiguous physical block addresses is associated with the first logical block address of the range of logical block addresses. In some examples, the data read component 435 may be configured as or otherwise support a means for reading data stored to non-volatile memory cells of the first portion of contiguous physical block addresses in response to determining that the first portion of contiguous physical block addresses is associated with the first logical block address, where a starting physical block address of the first portion corresponds to the first logical block address of the range of logical block addresses.

In some examples, the access command component 460 may be configured as or otherwise support a means for receiving a third read command that includes a second logical block address of the range of logical block addresses. In some examples, the LBA range component 465 may be configured as or otherwise support a means for determining whether the second portion of contiguous physical block addresses is associated with the second logical block address of the range of logical block addresses. In some examples, the data read component 435 may be configured as or otherwise support a means for reading data stored to non-volatile memory cells of the second portion of contiguous physical block addresses in response to determining that the second portion of contiguous physical block addresses is associated with the second logical block address, where a starting physical block address of the second portion corresponds to the second logical block address and is consecutive to an ending physical block address of the first portion. In some examples, the range of logical block addresses includes a range of contiguous logical block addresses. In some examples, the first command includes a vendor unique command.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

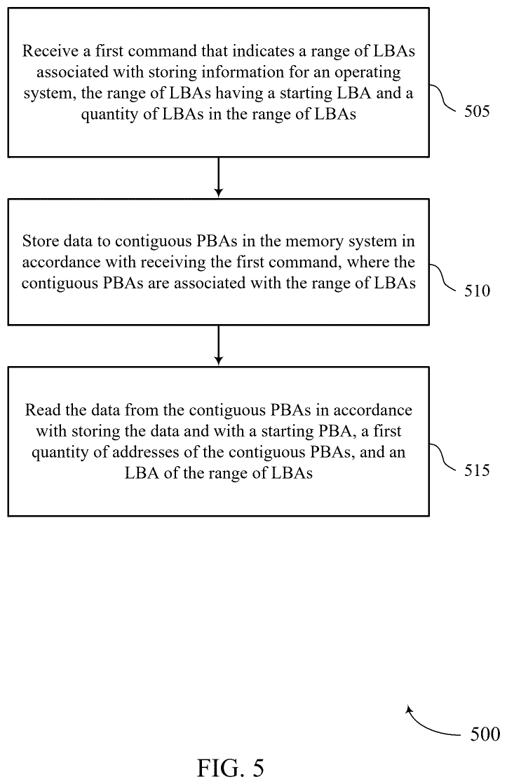

FIG. 5 shows a flowchart illustrating a method 500 that supports a read booster for operational data of a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a first command that indicates a range of logical block addresses associated with storing information for an operating system, the range of logical block addresses having a starting logical block address and a quantity of logical block addresses in the range of logical block addresses. In some examples, aspects of the operations of 505 may be performed by a VU command component 425 as described with reference to FIG. 4.

At 510, the method may include storing data to contiguous physical block addresses in the memory system in accordance with receiving the first command, where the contiguous physical block addresses are associated with the range of logical block addresses. In some examples, aspects of the operations of 510 may be performed by a contiguous PBA store component 430 as described with reference to FIG. 4.

At 515, the method may include reading the data from the contiguous physical block addresses in accordance with storing the data and with a starting physical block address, a first quantity of addresses of the contiguous physical block addresses, and a logical block address of the range of logical block addresses. In some examples, aspects of the operations of 515 may be performed by a data read component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects as disclosed herein:

Aspect 1: A method, apparatus, or non-transitory computer-readable medium including operations, features, circuitry, logic, means, or instructions, or any combination thereof for receiving a first command that indicates a range of logical block addresses associated with storing information for an operating system, the range of logical block addresses having a starting logical block address and a quantity of logical block addresses in the range of logical block addresses; storing data to contiguous physical block addresses in the memory system in accordance with receiving the first command, where the contiguous physical block addresses are associated with the range of logical block addresses; and reading the data from the contiguous physical block addresses in accordance with storing the data and with a starting physical block address, a first quantity of addresses of the contiguous physical block addresses, and a logical block address of the range of logical block addresses.

Aspect 2: The method, apparatus, or non-transitory computer-readable medium of aspect 1, further including operations, features, circuitry, logic, means, or instructions, or any combination thereof for storing, to a volatile memory of the memory system, a mapping between the range of logical block addresses and the contiguous physical block addresses, where the mapping includes the range of logical block addresses, the starting physical block address, and the first quantity of addresses of the contiguous physical block addresses.

Aspect 3: The method, apparatus, or non-transitory computer-readable medium of aspect 2, where reading the data includes operations, features, circuitry, logic, means, or instructions, or any combination thereof for receiving a first read command for the data after storing the data to the contiguous physical block addresses, where the first read command includes at least one logical block address of the range of logical block addresses, where the data is read from the contiguous physical block addresses in accordance with receiving the first read command and the mapping stored to the volatile memory.

Aspect 4: The method, apparatus, or non-transitory computer-readable medium of any of aspects 1 through 3, further including operations, features, circuitry, logic, means, or instructions, or any combination thereof for allocating the contiguous physical block addresses in response to receiving the first command, where storing the data is in response to allocating the contiguous physical block addresses.

Aspect 5: The method, apparatus, or non-transitory computer-readable medium of any of aspects 1 through 4, where storing the data to the contiguous physical block addresses includes operations, features, circuitry, logic, means, or instructions, or any combination thereof for reading, as part of a maintenance operation, the data from one or more non-contiguous physical block addresses and writing the data to the contiguous physical block addresses.

Aspect 6: The method, apparatus, or non-transitory computer-readable medium of aspect 5, where the maintenance operation is performed as part of one or more background operations.

Aspect 7: The method, apparatus, or non-transitory computer-readable medium of any of aspects 1 through 6, where the data is stored to the contiguous physical block addresses during a duration that the memory system is idle.

Aspect 8: The method, apparatus, or non-transitory computer-readable medium of any of aspects 1 through 7, where the contiguous physical block addresses includes at least a first portion of contiguous physical block addresses, a second portion of contiguous physical block addresses, and a third portion of contiguous physical block addresses and each portion is associated with a respective starting logical block address and a respective quantity of physical block addresses.

Aspect 9: The method, apparatus, or non-transitory computer-readable medium of aspect 8, further including operations, features, circuitry, logic, means, or instructions, or any combination thereof for receiving a second read command that includes a first logical block address of the range of logical block addresses; determining whether the first portion of contiguous physical block addresses is associated with the first logical block address of the range of logical block addresses; and reading data stored to non-volatile memory cells of the first portion of contiguous physical block addresses in response to determining that the first portion of contiguous physical block addresses is associated with the first logical block address, where a starting physical block address of the first portion corresponds to the first logical block address of the range of logical block addresses.

Aspect 10: The method, apparatus, or non-transitory computer-readable medium of any of aspects 8 through 9, further including operations, features, circuitry, logic, means, or instructions, or any combination thereof for receiving a third read command that includes a second logical block address of the range of logical block addresses; determining whether the second portion of contiguous physical block addresses is associated with the second logical block address of the range of logical block addresses; and reading data stored to non-volatile memory cells of the second portion of contiguous physical block addresses in response to determining that the second portion of contiguous physical block addresses is associated with the second logical block address, where a starting physical block address of the second portion corresponds to the second logical block address and is consecutive to an ending physical block address of the first portion.

Aspect 11: The method, apparatus, or non-transitory computer-readable medium of any of aspects 1 through 10, where the range of logical block addresses includes a range of contiguous logical block addresses.

Aspect 12: The method, apparatus, or non-transitory computer-readable medium of any of aspects 1 through 11, where the first command includes a vendor unique command.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the examples as disclosed herein. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first command that indicates a range of logical block addresses associated with storing information for an operating system, the range of logical block addresses having a starting logical block address and a quantity of logical block addresses in the range of logical block addresses;
store data to contiguous physical block addresses in the memory system in accordance with receiving the first command, wherein the contiguous physical block addresses are associated with the range of logical block addresses; and
read the data from the contiguous physical block addresses in accordance with storing the data and with a starting physical block address, a first quantity of addresses of the contiguous physical block addresses, and a logical block address of the range of logical block addresses.

2. The memory system of claim 1, wherein the processing circuitry is further configured to cause the memory system to:
store, to a volatile memory of the memory system, a mapping between the range of logical block addresses and the contiguous physical block addresses, wherein the mapping comprises the range of logical block addresses, the starting physical block address, and the first quantity of addresses of the contiguous physical block addresses.

3. The memory system of claim 2, wherein reading the data comprises the processing circuitry configured to cause the memory system to:
receive a first read command for the data after storing the data to the contiguous physical block addresses, wherein the first read command comprises at least one logical block address of the range of logical block addresses, and wherein the data is read from the contiguous physical block addresses in accordance with receiving the first read command and the mapping stored to the volatile memory.

4. The memory system of claim 1, wherein the processing circuitry is further configured to cause the memory system to:
allocate the contiguous physical block addresses in response to receiving the first command, wherein storing the data is in response to allocating the contiguous physical block addresses.

5. The memory system of claim 1, wherein storing the data to the contiguous physical block addresses comprises the processing circuitry configured to cause the memory system to:
read, as part of a maintenance operation, the data from one or more non-contiguous physical block addresses; and
write the data to the contiguous physical block addresses.

6. The memory system of claim 5, wherein the maintenance operation is performed as part of one or more background operations.

7. The memory system of claim 1, wherein the data is stored to the contiguous physical block addresses during a duration that the memory system is idle.

8. The memory system of claim 1, wherein the contiguous physical block addresses comprises at least a first portion of contiguous physical block addresses, a second portion of contiguous physical block addresses, and a third portion of contiguous physical block addresses, and wherein each portion is associated with a respective starting logical block address and a respective quantity of physical block addresses.

9. The memory system of claim 8, wherein the processing circuitry is further configured to cause the memory system to:
receive a second read command that comprises a first logical block address of the range of logical block addresses;
determine whether the first portion of contiguous physical block addresses is associated with the first logical block address of the range of logical block addresses; and
read data stored to non-volatile memory cells of the first portion of contiguous physical block addresses in response to determining that the first portion of contiguous physical block addresses is associated with the first logical block address, wherein a starting physical block address of the first portion corresponds to the first logical block address of the range of logical block addresses.

10. The memory system of claim 8, wherein the processing circuitry is further configured to cause the memory system to:
receive a third read command that comprises a second logical block address of the range of logical block addresses;
determine whether the second portion of contiguous physical block addresses is associated with the second logical block address of the range of logical block addresses; and
read data stored to non-volatile memory cells of the second portion of contiguous physical block addresses in response to determining that the second portion of contiguous physical block addresses is associated with the second logical block address, wherein a starting physical block address of the second portion corresponds to the second logical block address and is consecutive to an ending physical block address of the first portion.

11. The memory system of claim 1, wherein the range of logical block addresses comprises a range of contiguous logical block addresses.

12. The memory system of claim 1, wherein the first command comprises a vendor unique command.

13. A non-transitory computer-readable medium storing code comprising instructions which, when executed by one or more processors of a memory system, cause the memory system to:
receive a first command that indicates a range of logical block addresses associated with storing information for an operating system, the range of logical block addresses having a starting logical block address and a quantity of logical block addresses in the range of logical block addresses;
store data to contiguous physical block addresses in the memory system in accordance with receiving the first command, wherein the contiguous physical block addresses are associated with the range of logical block addresses; and
read the data from the contiguous physical block addresses in accordance with storing the data and with a starting physical block address, a first quantity of addresses of the contiguous physical block addresses, and a logical block address of the range of logical block addresses.

14. The non-transitory computer-readable medium of claim 13, wherein the instructions, when executed by the one or more processors of the memory system, further cause the memory system to:
store, to a volatile memory of the memory system, a mapping between the range of logical block addresses and the contiguous physical block addresses, wherein the mapping comprises the range of logical block addresses, the starting physical block address, and the first quantity of addresses of the contiguous physical block addresses.

15. The non-transitory computer-readable medium of claim 14, wherein the instructions to read the data, when executed by the one or more processors of the memory system, cause the memory system to:
receive a first read command for the data after storing the data to the contiguous physical block addresses, wherein the first read command comprises at least one logical block address of the range of logical block addresses, and wherein the data is read from the contiguous physical block addresses in accordance with receiving the first read command and the mapping stored to the volatile memory.

16. The non-transitory computer-readable medium of claim 13, wherein the instructions, when executed by the one or more processors of the memory system, further cause the memory system to:
allocate the contiguous physical block addresses in response to receiving the first command, wherein storing the data is in response to allocating the contiguous physical block addresses.

17. The non-transitory computer-readable medium of claim 13, wherein the instructions to store the data to the contiguous physical block addresses, when executed by the one or more processors of the memory system, cause the memory system to:
read, as part of a maintenance operation, the data from one or more non-contiguous physical block addresses; and
write the data to the contiguous physical block addresses.

18. The non-transitory computer-readable medium of claim 17, wherein the maintenance operation is performed as part of one or more background operations.

19. The non-transitory computer-readable medium of claim 13, wherein the data is stored to the contiguous physical block addresses during a duration that the memory system is idle.

20. The non-transitory computer-readable medium of claim 13, wherein the contiguous physical block addresses comprises at least a first portion of contiguous physical block addresses, a second portion of contiguous physical block addresses, and a third portion of contiguous physical block addresses, wherein each portion is associated with a respective starting logical block address and a respective quantity of physical block addresses.

21. The non-transitory computer-readable medium of claim 20, wherein the instructions, when executed by the one or more processors of the memory system, further cause the memory system to:
receive a second read command that comprises a first logical block address of the range of logical block addresses;
determine whether the first portion of contiguous physical block addresses is associated with the first logical block address of the range of logical block addresses; and
read data stored to non-volatile memory cells of the first portion of contiguous physical block addresses in response to determining that the first portion of contiguous physical block addresses is associated with the first logical block address, wherein a starting physical block address of the first portion corresponds to the first logical block address of the range of logical block addresses.

22. The non-transitory computer-readable medium of claim 20, wherein the instructions, when executed by the one or more processors of the memory system, further cause the memory system to:
receive a third read command that comprises a second logical block address of the range of logical block addresses;
determine whether the second portion of contiguous physical block addresses is associated with the second logical block address of the range of logical block addresses; and
read data stored to non-volatile memory cells of the second portion of contiguous physical block addresses in response to determining that the second portion of contiguous physical block addresses is associated with the second logical block address, wherein a starting physical block address of the second portion corresponds to the second logical block address and is consecutive to an ending physical block address of the first portion.

23. The non-transitory computer-readable medium of claim 13, wherein the range of logical block addresses comprises a range of contiguous logical block addresses.

24. The non-transitory computer-readable medium of claim 13, wherein the first command comprises a vendor unique command.

25. A method by a memory system, comprising:
receiving a first command that indicates a range of logical block addresses associated with storing information for an operating system, the range of logical block addresses having a starting logical block address and a quantity of logical block addresses in the range of logical block addresses;
storing data to contiguous physical block addresses in the memory system in accordance with receiving the first command, wherein the contiguous physical block addresses are associated with the range of logical block addresses; and
reading the data from the contiguous physical block addresses in accordance with storing the data and with a starting physical block address, a first quantity of addresses of the contiguous physical block addresses, and a logical block address of the range of logical block addresses.
